(19) United States
(12) Patent Application Publication
(10) Pub. No.: US 2022/0174240 A1
(43) Pub. Date: Jun. 2, 2022

(54) GLOBAL TRACKING SYSTEM AND CLOUD SYSTEM THEREOF

(71) Applicants: BigObject Inc., Taipei City (TW); Certis CISCO Security Pte Ltd, Singapore (SG)

(72) Inventors: Wenwey HSEUSH, Taipei City (TW); Shyy San FOO, Singapore (SG)

(21) Appl. No.: 17/108,873

(22) Filed: Dec. 1, 2020

(51) Int. Cl. H04N 7/18; G06F 16/53

(52) U.S. Cl. CPC H04N 7/181; G06K 9/00664; G06F 16/53

(57) ABSTRACT

Global tracking systems and cloud systems thereof are provided. Several image capturing devices are deployed in a space. Each image capturing device sees a pre-designated view area in the space, and the space has blind area(s) uncovered. The processor(s) receives a sequence of images from each image capturing device, detect several object instances from the images, and generate an object record for each object instance. Each object record has a tracking identity, a timestamp, and a geographical coordinate where the corresponding object located. The object records with the same tracking identity correspond to the same object and the same image capturing device. The processor(s) determines that a specific object has no object record within a pre-determined time interval, finds a specific object record corresponding to a last appearance of the specific object, and projects that the specific object is entering into a specific blind area in the pre-determined time interval.

### FIELD OF THE INVENTION

The present invention relates to global tracking systems and cloud systems thereof. Specifically, the present invention relates to global tracking systems and cloud systems thereof that re-identify cross-boundary objects and joining objects in terms of geographical coordinates.

### BACKGROUND OF THE INVENTION

In today's security industry, images captured by image capturing devices are the important elements for many security-critical applications. Recent development of Artificial Intelligence (AI) and edge computing plays a critical role to capture single-sourced sensory events (e.g., detecting an unattended suitcase with an image capturing device), which, nevertheless, tell partial and probably imprecise information, rather than the whole truth. Putting together multiple streams of events for cross examination is the way to detect and figure out what actually happened on the field.

One of the key issues immediately following the detection of a meaningful event is to track and trace the moving objects related to the event in a vast area. The problem is referred to as global tracking (or extensive tracking), to differ from the traditional tracking problem that associates an object from one frame to another in one single image capturing device. The algorithm that re-identifies cross-boundary objects in global tracking problem is referred to global re-identification (or extensive re-identification), which emphasizes the issues related to the complexity behind a great number of image capturing devices. The goal of global tracking is to project the trajectory of every object moving within a surveillance area in an accurate and efficient way.

For global re-identification, the challenge becomes severe when there are blind areas uncovered by the image capturing device and/or when the number of image capturing devices increases substantially, which impose difficulties in achieving high accuracy while maintaining real-time performance. A real-world example is to monitor thousands of passengers passing under hundreds of image capturing devices during rush hours in a bus station. In such an extensive environment, the key issue leading to inaccuracy is the large number of candidates to be screened by feature comparison as well as some objects may enter into or exit from blind areas.

Consequently, a global tracking technology that can re-identify cross-boundary objects efficiently and effectively and handle the situations that objects entering into and exiting from blind areas is in an urgent need.

### SUMMARY OF THE INVENTION

An objective of the present invention is to provide a global tracking system, which may be deployed in a space. The global tracking system comprises a plurality of image capturing devices and at least one processor. Each of the image capturing devices sees a pre-designated view area in the space, and the image capturing devices leave out at least one blind area uncovered by the image capturing devices in the space. The at least one processor is configured to receive a sequence of images from each of the image capturing devices, detect a plurality of object instances, and generate an object record for each of the object instances. Each of the object instances is detected from one of the images. Each of the object records comprises a tracking identity, a timestamp, and a geographical coordinate where the corresponding object located, and the object records with the same tracking identity correspond to the same object and the same image capturing device.

The at least one processor is configured to determine that a specific object among the objects has no object record within a pre-determined time interval, find a specific object record corresponding to a last appearance of the specific object from the object records, and project that the specific object is entering into a specific blind area of the at least one blind area in the pre-determined time interval according to the geographical coordinate comprised in the specific object record. A distance between the geographical coordinate comprised in the specific object record and a boundary of the specific blind area is within a pre-determined range.

Another objective of the present invention is to provide a global tracking system, which may be deployed in a space. The global tracking system comprises a plurality of image capturing devices and at least one processor. Each of the image capturing devices sees a pre-designated view area in the space, and the image capturing devices leave out at least one blind area uncovered by the image capturing devices in the space. The at least one processor is configured to receive a sequence of images from each of the image capturing devices, detect a plurality of object instances, and generate an object record for each of the object instances. Each of the object instances is detected from one of the images. Each of the object instances corresponds to an object record, and each of the object records comprises a tracking identity, a timestamp, and a geographical coordinate where the corresponding object located. The object records with the same tracking identity correspond to the same object and the same image capturing device.

The at least one processor is configured to detect a first appearance of a specific object viewed by a specific image capturing device, and the first appearance happened at a first time instant and at a first geographical coordinate. The at least one processor is configured to deduce at least one candidate object that is entering and has not exited from a specific blind area due to having no object record generated after entering the specific blind area according to a model based on the first time instant, the first geographical coordinate, and a second geographical coordinate and a second time instant of each candidate object record. The specific blind area is neighbor to the pre-designated view area corresponding to the specific image capturing device. The at least one processor is configured to determine that the specific object is one of the at least one candidate object by calculating a similarity between the specific object and each candidate object and determine that the specific object is exiting the specific blind area.

Yet another objective of the present invention is to provide a cloud system, which may be set up to cooperate with a plurality of existing image capturing devices. Each of the image capturing devices is configured to see a pre-designated view area in a space, and the image capturing devices leaves out at least one blind area uncovered by the image capturing devices in the space. The cloud system comprises a transceiving interface and at least one processor, wherein the at least one processor is electrically connected to the transceiving interface. The transceiving interface is configured to receive a sequence of images from each of the image capturing devices. The at least one processor is configured to detect a plurality of object instances and generate an object record for each of the object instances. Each of the object instances is detected from one of the images. Each of the object records comprises a tracking identity, a timestamp, and a geographical coordinate where the corresponding object located, and the object records with the same tracking identity correspond to the same object and the same image capturing device.

The at least one processor is configured to determine that a specific object among the objects has no object record within a pre-determined time interval, find a specific object record corresponding to a last appearance of the specific object from the object records, and project that the specific object is entering into a specific blind area of the at least one blind area in the pre-determined time interval according to the geographical coordinate comprised in the specific object record. A distance between the geographical coordinate comprised in the specific object record and a boundary of the specific blind area is within a pre-determined range.

A further objective of the present invention is to provide a cloud system, which may be set up to cooperate with a plurality of existing image capturing devices. Each of the image capturing devices is configured to see a pre-designated view area in a space, and the image capturing devices leaving out at least one blind area uncovered by the image capturing devices in the space. The cloud system comprises a transceiving interface and at least one processor, wherein the at least one processor is electrically connected to the transceiving interface. The transceiving interface is configured to receive a sequence of images from each of the image capturing devices. The at least one processor is configured to detect a plurality of object instances and generate an object record for each of the object instances. Each of the object instances is detected from one of the images, and each of the object instances corresponds to an object record. Each of the object records comprises a tracking identity, a timestamp, and a geographical coordinate where the corresponding object located, wherein the object records with the same tracking identity correspond to the same object and the same image capturing device.

The at least one processor is configured to detect a first appearance of a specific object viewed by a specific image capturing device, and the first appearance happened at a first time instant and at a first geographical coordinate. The at least one processor is configured to deduce at least one candidate object that is entering and has not exited from a specific blind area due to having no object record generated after entering the specific blind area according to a model based on the first time instant, the first geographical coordinate, and a second geographical coordinate and a second time instant of each candidate object record. The specific blind area is neighbor to the pre-designated view area corresponding to the specific image capturing device. The at least one processor is configured to determine that the specific object is one of the at least one candidate object by calculating a similarity between the specific object and each candidate object and determine that the specific object is exiting the specific blind area.

The global tracking systems and the cloud systems thereof provided by the present invention adopt a spatial-temporal awareness approach to track every moving object within the space. The global tracking systems and the cloud systems thereof have the ability of re-identifying cross-boundary objects and the ability of joining objects in the overlapped view areas in terms of geographical coordinates. The core idea of the invention is to adopt a blind area model to significantly narrow down the number of the candidates before a feature-based re-identification algorithm is applied. The global tracking systems and the cloud systems thereof extend beyond operations of security, safety, and friendly community and can be potentially deployed to transform passengers' experience in aviation hub, commuters' experience in transport hub, consumers' experience in retail malls, patient's experience in hospitals and finally users' experience in precincts.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic view of the global tracking system 1 in an embodiment according to the present invention;

FIG. 2 illustrates a specific example of the deployment of the image capturing devices C1, C2, C3, C4 in the space S;

FIG. 3 illustrates a schematic view of the global tracking system 1 in some other embodiments according to the present invention;

FIG. 4 illustrates a specific example regarding tracking an object that is entering into a blind area;

FIG. 5 illustrates a specific example regarding tracking an object that is exiting from a blind area; and

FIG. 6 illustrates a specific example regarding tracking an object in an overlapped view area.

### DETAILED DESCRIPTION

In the following description, global tracking systems and cloud systems thereof provided according to the present invention will be explained with reference to embodiments thereof. However, these embodiments of the present invention are not intended to limit the present invention to any specific environment, applications, or implementations described in these embodiments. Therefore, description of these embodiments is only for purpose of illustration rather than to limit the scope of the present invention. It shall be appreciated that, in the following embodiments and the attached drawings, elements unrelated to the present invention are omitted from depiction. In addition, dimensions of elements and dimensional proportions among individual elements in the attached drawings are provided only for ease of depiction and illustration, but not to limit the scope of the present invention.

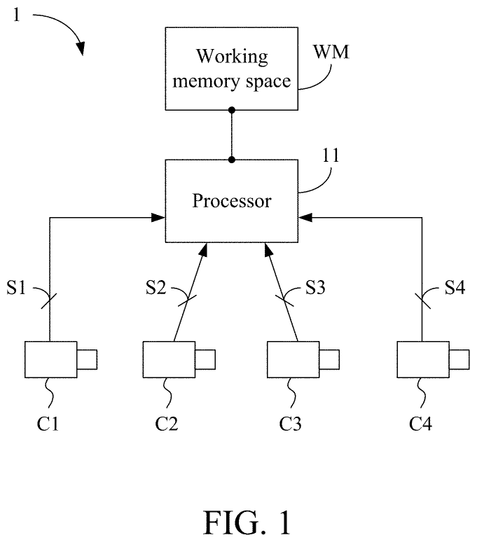

An embodiment of the present invention is a global tracking system 1, and a schematic view of which is illustrated in FIG. 1. The global tracking system 1 comprises four image capturing devices C1, C2, C3, C4. Please note that the aforesaid number of image capturing devices is just an example. The present invention does not limit the number of image capturing devices comprised in the global tracking system 1 to any specific number as long as it is more than one.

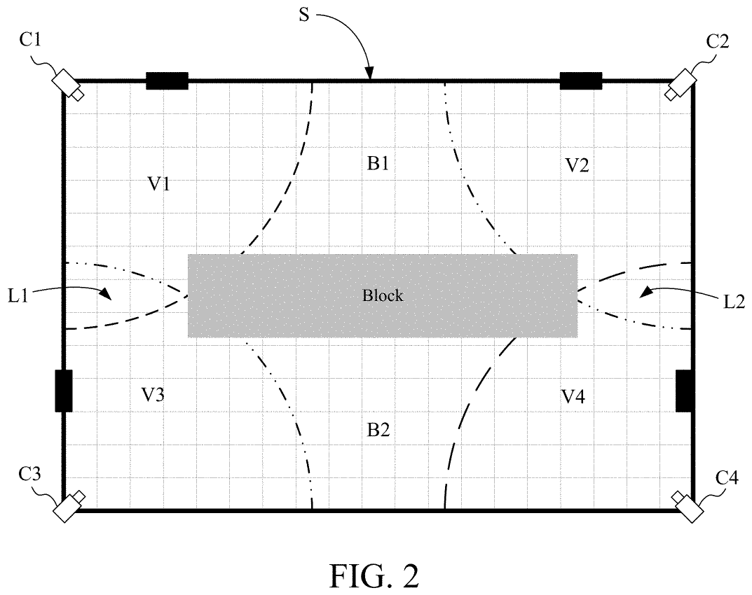

The image capturing devices C1, C2, C3, C4 are deployed in a space S, which may be a vast public area such as an airport, a bus station, or the like. It is assumed that each of the image capturing devices C1, C2, C3, C4 is individually fixed at a specific location, with potential parameters such as angle, height, and many camera-specific parameters. It is possible that one of or more of the image capturing devices C1, C2, C3, C4 is/are equipped on a robot (or robots), and the robot(s) stand(s) at a specific location. FIG. 2 illustrates a specific example of the deployment of the image capturing devices C1, C2, C3, C4 in the space S, which, however, is not used to limit the scope of the present invention. The image capturing devices C1, C2, C3, C4 respectively see the pre-designated view areas V1, V2, V3, V4 in the space S and leave out two blind area B1, B2 uncovered by the image capturing devices C1, C2, C3, C4 in the space S. There is an overlapped view area L1 between the pre-designated view areas V1, V3, and there is another overlapped view area L2 between the pre-designated view areas V2, V4. The aforesaid numbers of blind areas and overlapped view areas in the space S are simply examples and are not intended to limit the scope of the present invention. In FIG. 2, the area where no people can enter or pass through is labeled as “block.”

The space S may be gridded into a finite set of rectangular cells (e.g. comprising a latitude and a longitude rounded up to the n^{th} decimal place) as shown in FIG. 2, wherein each of the rectangular cells may be identified by a geographical coordinate (or a geohash). Since each of the pre-designated view areas V1, V2, V3, V4 is a portion of the space S, each of the pre-designated view areas V1, V2, V3, V4 covers some geographical coordinates of the space S.

A mapping function is defined between a pre-designated view area (i.e. each of the pre-designated view areas V1, V2, V3, V4) and an image captured by the corresponding image capturing device. With the mapping function, every pixel within an image captured by the image capturing device can be mapped to a geographical coordinate covered by the corresponding pre-designated view area. Taking the image capturing device C1 and the corresponding pre-designated view area V1 as an example, every pixel within an image captured by the image capturing device C1 can be mapped to one of the geographical coordinates covered by the pre-designated view area V1 according to the corresponding mapping function. Therefore, if an object instance is detected from an image captured by the image capturing device C1, the geographical coordinate(s) that the object located in the pre-designated view area V1 can be derived by the mapping function and the pixels where the object instance is detected (e.g. inputting the positions of the pixels into the mapping function).

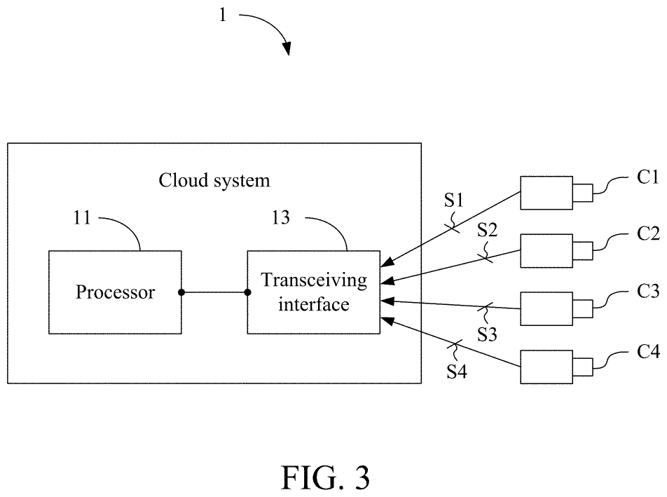

In this embodiment, the global tracking system 1 further comprises a processor 11, and the processor 11 is in charge of all the operations in this embodiment. In some other embodiments, the global tracking system 1 may comprise more than one processor, wherein some processor(s) is/are in charge of detecting object instances from images and generating object records for the object instances and other processor(s) is/are in charge of re-identifying cross-boundary objects (will be described in details later) and/or joining objects in terms of geographical coordinates (will be described in details later). In some other embodiments, the at least one processor may be deployed in a cloud system as shown in FIG. 3 and the at least one processor receives sequences of images from the image capturing devices C1, C2, C3, C4 through a transceiving interface 13 of the cloud system. Yet, in some other embodiments, the global tracking system 1 may comprise more than one processor, wherein some of them is/are deployed in a cloud system and some of them is/are deployed at edge.

Each of the aforesaid processors (e.g. the processor 11) may be one of various processors, Graphics Processing Unit (GPU), central processing units (CPUs), microprocessor units (MPUs), digital signal processors (DSPs), or other computing apparatuses well-known to a person having ordinary skill in the art. The transceiving interface 13 may be a wired transmission interface or a wireless transmission interface known to a person having ordinary skill in the art, which is used to be connected to a network (e.g., an Internet, a local area network) and may receive and transmit signals and data on the network.

In this embodiment, the processor 11 receives sequences S1, S2, S3, S4 of images from the image capturing devices C1, C2, C3, C4 respectively. Every time the processor 11 receives an image (in either of the sequences S1, S2, S3, S4), the processor 11 tries to detect object instance(s) therefrom by an object detection algorithm (e.g. Yolo) and a tracking algorithm (e.g., Deep SORT). If an object instance is detected, the processor 11 generates an object record for that object instance. Each of the object records comprises a tracking identity generated by a local tracking algorithm, a timestamp (e.g. the time instant that the image is captured), and the geographical coordinate where the corresponding object located in the space S. The aforesaid tracking identities are locally unique to the corresponding image capturing device; that is, the object records with the same tracking identity correspond to the same object and the same image capturing device.

The global tracking system 1 may comprise a working memory space WM for storing the object records. In some embodiments, the working memory space WM retains object records for every object seen over the past period (e.g. 120 seconds), and object records that live longer than the past period will be immediately deleted from the working memory space WM. The working memory space WM is electrically connected to the processor 11 and may be one of a Random-Access Memory (RAM), a non-volatile memory, an HDD, or any other non-transitory storage media or apparatuses with the same function and well-known to a person having ordinary skill in the art.

In this embodiment, the global tracking system 1 can track every moving object within the space S due to having the ability of re-identifying cross-boundary objects and the ability of joining objects in the overlapped view areas in terms of geographical coordinates. The technique regarding re-identification of cross-boundary objects is further divided into two situations, including (a) tracking an object that is entering into (or considered as disappearing into) a blind area and (b) tracking an object that is exiting from a blind area. All of them will be given in details below.

### A. Tracking an Object That is Entering Into a Blind Area

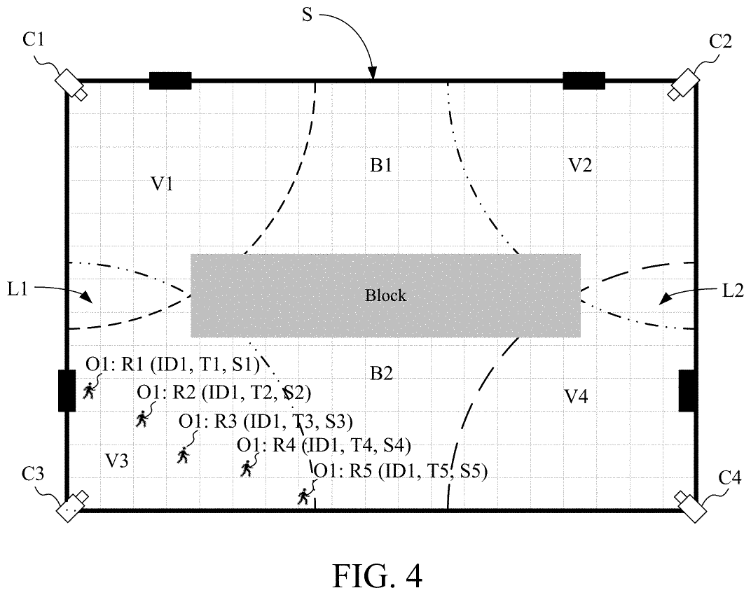

Herein, the operations regarding tracking an object that is entering into a blind area will be described in details with reference to a specific example shown in FIG. 4, where by definition, objects in a blind area are not visually trackable. Please note that the specific example is not intended to limit the scope of the present invention.

In this specific example, a specific object O1 is moving in the pre-designated view area V3 and is captured by the image capturing device C3 in five images. The processor 11 detects an object instance from each of the five images, identifies that the object instances correspond to the same specific object O1 (by a local tracking algorithm), and generates an object record for each of the detected object instances. Specifically, five object records R1, R2, R3, R4, R5 corresponding to the specific object O1 are generated. Since the processor 11 identifies that the object instances correspond to the same specific object O1, the five object records R1, R2, R3, R4, R5 comprises the same tracking identity ID1. Furthermore, the five object records R1, R2, R3, R4, R5 respectively comprise the timestamps T1, T2, T3, T4, T5 (e.g. the time instants that the corresponding images are captured) and respectively comprise the geographical coordinates S1, S2, S3, S4, S5 (i.e. where the specific object O1 is located in the pre-designated view area V3 of the space S when the corresponding image is captured) .

At some point, the processor 11 determines that the specific object O1 has no object record within a pre-determined time interval (e.g. 0.437 second), which means that the processor 11 loses the track of the specific object O1. The processor 11 tries to find a specific object record corresponding to a last appearance of the specific object O1 from the object records that have been generated and collected (which may be stored in the working memory space WM). In the specific example shown in FIG. 4, the processor 11 finds the specific object record R5 corresponding to the last appearance of the specific object O1. The processor 11 further examines the geographical coordinate recorded in the specific object record R5 to determine whether the specific object O1 is entering into a specific blind area of the blind areas B1, B2 in the pre-determined time interval. In this specific example, the processor 11 finds out that a distance between the geographical coordinate comprised in the specific object record R5 and a boundary of the specific blind area B2 is within a pre-determined range. As a conclusion, the processor 11 projects that the specific object O1 is entering into the specific blind area B2 in the pre-determined time interval.

In some embodiments, the processor 11 may refer to a probability model (e.g. a probability model based on Poisson distribution) in order to determine whether to project the specific object O1 having entered into the specific blind area B2 in the pre-determined time interval. In those embodiments, the probability model generates a probability based on a last-appeared time of the specific object O1 (i.e. the timestamp recorded in the specific object record R5, which corresponds to the last appearance of the specific object O1) and the distance between the geographical coordinate comprised in the specific object record R5 and the boundary of the specific blind area B2. If the probability is greater than a predetermined threshold, the processor 11 projects that the specific object O1 is entering into the specific blind area B2 in the pre-determined time interval.

### B. Tracking an Object That is Exiting From a Blind Area

Herein, the operations regarding tracking an object that is exiting from a blind area will be described in details. Briefly speaking, once an object shows up in one of the pre-designated view areas V1, V2, V3, V4, the processor 11 projects the movement of the object coming from the pre-designated view areas adjacent to the blind area. The processor 11 looks for potential candidates in the working memory space WM, which retains object records for every object seen over the past period (e.g. 120 seconds). The size of the initial set of candidate objects is potentially large. The processor 11 then substantially narrow down the potential candidate objects to a very limited set (e.g. two or three). Once candidates are narrowed down, the feature-based model is applied to re-identify the object (i.e., find out from which pre-designated view area the person comes).

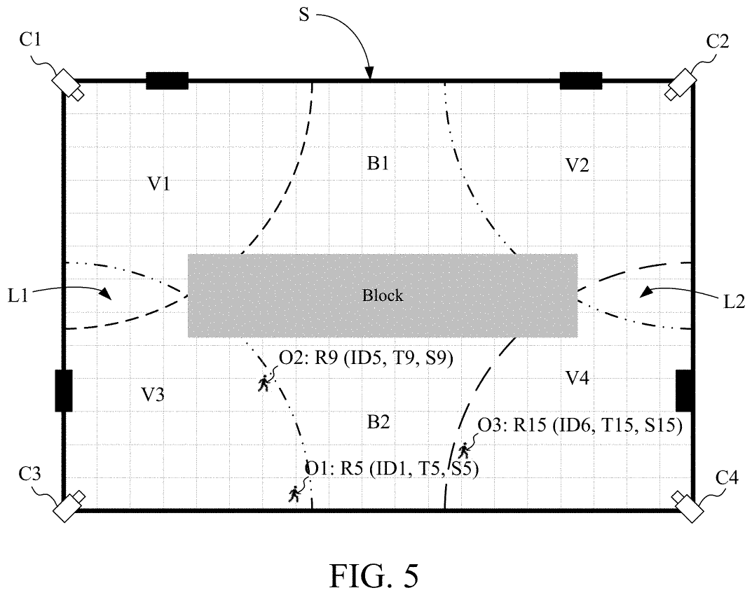

For comprehension, a specific example shown in FIG. 5 is given, which, however, is not intended to limit the scope of the present invention. In this specific example, a specific object O3 is moving in the pre-designated view area V4 and is captured by the image capturing device C4 in an image. The processor 11 detects an object instance from the image, where the object instance is a first appearance of the specific object O3 viewed by the specific image capturing device C4, and generates an object record R15 for the detected object instance. The object record R15 comprises a tracking identity ID6 (which is a new tracking identity because it corresponds to the first appearance of the specific object O3 viewed by the specific image capturing device C4), a timestamp T15 (i.e. the time instant that the corresponding image is captured, which is also the time instant that the first appearance of the specific object O3 happened), and a geographical coordinate S15 where the specific object O3 located when the corresponding image is captured (which is also the geographical coordinate that the first appearance of the specific object O3 happened).

As it is the first appearance of the specific object O3 viewed by the specific image capturing device C4, the processor 11 further determines whether the specific object O3 exits from the specific blind area B2 neighboring to the pre-designated view area V4. In the specific example shown in FIG. 5, the processor 11 deduces two candidate objects O1, O2 that is entering and has not exited from the specific blind area B2 due to having no object record generated after entering the specific blind area B2. The deduction is according to a model based on the time instant of the first appearance of the specific object O3, the geographical coordinate of the first appearance of the specific object O3, and the geographical coordinate and the timestamp of the candidate object record corresponding to each of the candidate objects O1, O2. In this specific example, the candidate object records R5, R9 respectively correspond to the candidate objects O1, O2. The candidate object record R5 comprises the tracking identity ID1, the timestamp T5, and the geographical coordinate S5, while the candidate object record R9 comprises the tracking identity ID5, the timestamp T9, and the geographical coordinate S9.

In some embodiments, the processor 11 may deduce the two candidate objects O1, O2 from the objects retained in the working memory WM with reference to a probability model (e.g. a hidden Markov Chain model). For each of the candidate objects O1, O2, the probability model generates a probability based on the geographical coordinate of the first appearance of the specific object O3, the geographical coordinate corresponding to the candidate object, and a time length between the time instant of the first appearance of the specific object O3 and the time instant corresponding to the candidate object. Please note that the geographical coordinate S15 and the time instant of the first appearance of the specific object O3 is recorded in the object record R15, the geographical coordinate and the time instant of candidate object O1 is recorded in the object record R5, and the geographical coordinate and the time instant of candidate object O2 is recorded in the object record R9. The candidate objects O1, O2 are chosen to be the candidates of the specific object O3 because the corresponding probabilities are greater than another predetermined threshold.

After deriving the candidate objects O1, O2, the processor 11 calculates a similarity between the specific object O3 and each of the candidate objects O1, O2 in a feature-based manner. If the largest similarity among the similarities is greater than a predetermined threshold, the processor 11 determines that the specific object O3 is the candidate object corresponding to the largest similarity and determines that the specific object O3 is exiting the specific blind area B2. For convenience, it is assumed that the similarity between the specific object O3 and the candidate objects O2 is the largest one and is greater than the predetermined threshold. Thus, the processor 11 considers that the specific object O3 and the candidate objects O2 are the same object, and the candidate objects O2 is the “predecessor” of the specific object O3. It can be considered as the specific object O3 is entering into the specific blind area B2 from the pre-designated view area V3, has traversed through the specific blind area B2, and is exiting from the specific blind area B2 into pre-designated view area V4.

### Blind Area Model

The aforesaid probability model (may be referred to as “a blind area model”) for deducing candidate object(s) is elaborated herein. The blind area model is used to precisely project the trajectories of the objects moving throughout the vast space. A blind area is mathematically a bag (denoted as “B”), that an object can be added into (i.e., enter into the blind area) and removed from (i.e., exit from the blind area) at a later time. The blind area model is aimed to address three issues as follows:

1. To project when and from which geographical coordinate an object enters into a blind area (i.e. entering the bag “B”);

2. To detect when and from which geographical coordinate an object (denoted as “o”) exits from the bag “B”; and

3. To deduce a limited subset of candidates from the bag “B” for feature matching with the object “o”.

Remember that all objects are anonymous and can be only seen from the pre-designated view areas. By the definition of blindness, there is no way to know the real status of objects in a blind area. The first issue is addressed by determining whether the appearance of an object is the last one seen in a view area, moving near and toward a blind area adjacent to the view area. The last appearance can only be estimated probabilistically with a no-show event after a short period of silence, even though it is not sufficient to prove that the object is indeed entering into a blind area. For an object tracked by the local tracking algorithm, losing track does not mean disappearing into a blind area. It may lose track temporarily and re-appear in a few frames. A mathematical model is trained to determine the probability of entering into a blind area.

The second issue is addressed by detecting the first appearance of an object “o” in a view area, which is geo-spatially located very close to a blind area. The detection of the first appearance does not prove the object “o” exiting from a blind area if its lineage cannot be traced, that is, its origin, what happens to it and where it moves over time. This leads to the next question—where does the object “o” come from? That is, to re-identify the object “o”.

In an extensive environment, one of the critical factors for effective re-identification is the number of candidates selected for feature matching. Reducing the potential candidates from dozens to a few will significantly increase the overall accuracy of extensive tracking. With the prior knowledge of the blind areas, the goal can be achieved by projecting the probable trails of objects inside the blind area and therefore filtering out those spatially and temporally impossible. Finally, the feature comparison algorithm is applied to re-identify o out of the potential candidates. That is, linking o with the most likely one that disappeared into the blind area a few moments earlier. Effective re-identification assures both accuracy and performance.

A hidden Markov Chain model may be adopted to deduce the potential candidates out of all possible objects that entered into a blind area. With data collected on the field, the model is trained to determine the probability distribution, P(x, y, t), where the parameter t is the duration between the time entering at the geographical coordinate x and the time exiting at the geographical coordinate y. With the model, when a first-time object that shows up at the geographical coordinate y from a blind area, all potential candidates that disappeared into the blind area in a reasonable time range from possible geographical coordinate x's are selected and matched for re-identification.

### C. Joining Objects in the Overlapped View Areas in Terms of Geographical Coordinates

Herein, the operations regarding joining objects in the overlapped view areas in terms of geographical coordinates (i.e. tracking an object in an overlapped view area) will be described in details. For the situation of overlapped view areas, “joining objects in terms of geographical coordinates” associates one object viewed by one image capturing device with another according to the exclusion principle, which states that two distinct persons cannot show up at the same location in the same time, and therefore two instances with the same geohashes can be considered as the same person.

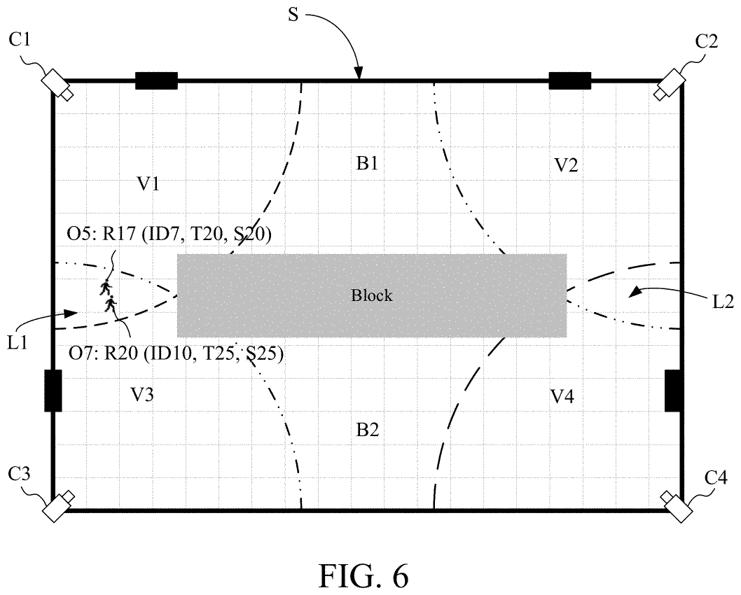

A specific example is given in FIG. 6 for describing the details of joining objects in an overlapped view area in terms of geographical coordinates. Please note that the specific example is not intended to limit the scope of the present invention. In this specific example, an object is moving in the overlapped view area L1 and is captured by both the capturing devices C1, C3. The global tracking system 1 treats these two object instances corresponds to the same object.

Specifically, the object record R17 corresponds to the image capturing device C1 (i.e. the object record R17 is generated based on an object instance detected from an image captured by the image capturing device C1). The object record R17 comprises the tracking identity ID7, the timestamp T20, and the geographical coordinate S20. In addition, the object record R20 corresponds to the image capturing device C3 (i.e. the object record R20 is generated based on an object instance detected from an image captured by the image capturing device C3). The object record R20 comprises the tracking identity ID10, the timestamp T25, and the geographical coordinate S25).

The processor 11 determines that a distance between the geographical coordinate S20 comprised in the object record R17 and the geographical coordinate S25 comprised in the object record R20 is smaller than a first threshold and determines that a time difference between the timestamp T20 comprised in the object record R17 and the timestamp T25 comprised in the object record R20 is smaller than a second threshold. Based on the aforesaid determinations, the processor 11 considers that the first object instance corresponding to the object record R17 and the object instance corresponding to the object record R20 are overlapped and the object O5 corresponding to the object record R17 and the object O7 corresponding to the object record R20 are the same object in the real world (i.e. in the space S). This is based on the exclusion principle where two distinct persons cannot show up in the same location at the same time. Thus, the processor 11 adjusts the geographical coordinate comprised in the object record R17 to be the same as the geographical coordinate comprised in the object record R20.

In some embodiments, the processor 11 may further adjust the mapping function corresponding to the image capturing device C1 according to the distance between the geographical coordinate S20 comprised in the object record R17 and the geographical coordinate S25 comprised in the object record R20.

The convergence of digital capabilities across the digital and physical environment presents great opportunities for security industry to embrace a new frontier of digital transformation as the society continues to evolve with the rapidly shifting technological landscape. To address the leading physical security operation challenges of reactive threat management and intuition-led decision-making based on subjectivity, the security industry should adopt an operational design first approach, beyond technology and system implementation.

The global tracking system 1 adopts a spatial-temporal awareness approach to track every moving object within the space. The global tracking system 1 has the ability of re-identifying cross-boundary objects and the ability of joining objects in the overlapped view areas in terms of geographical coordinates. The core idea of the invention is to adopt a blind area model to significantly narrow down the number of the candidates before a feature-based re-identification algorithm is applied. The global tracking system 1 extends beyond operations of security, safety, and friendly community and can be potentially deployed to transform passengers' experience in aviation hub, commuters' experience in transport hub, consumers' experience in retail malls, patient's experience in hospitals and finally users' experience in precincts.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A global tracking system, comprising:
a plurality of image capturing devices being deployed in a space, wherein each of the image capturing devices sees a pre-designated view area in the space, and the image capturing devices leave out at least one blind area uncovered by the image capturing devices in the space; and
at least one processor, being configured to receive a sequence of images from each of the image capturing devices, detect a plurality of object instances, and generate an object record for each of the object instances, wherein each of the object instances is detected from one of the images, each of the object records comprises a tracking identity, a timestamp, and a geographical coordinate where the corresponding object located, and the object records with the same tracking identity correspond to the same object and the same image capturing device;
wherein the at least one processor determines that a specific object among the objects has no object record within a pre-determined time interval, finds out that a specific object record corresponds to a last appearance of the specific object from the object records in response to determining that the specific object has no object record within the pre-determined time interval, finds out that a distance between the geographical coordinate comprised in the specific object record and a boundary of a specific blind area of the at least one blind area is within a pre-determined range, and projects that the specific object is entering into the specific blind area in the pre-determined time interval in response to finding out that the distance between the geographical coordinate comprised in the specific object record and the boundary of the specific blind area is within the pre-determined range.

2. The global tracking system of claim 1, wherein the at least one processor projects that the specific object is entering into the specific blind area in the pre-determined time interval with reference to a probability model,
wherein the probability model generates a probability based on a last-appeared time of the specific object and the distance between the geographical coordinate comprised in the specific object record and the boundary of the specific blind area.

3. The global tracking system of claim 1, wherein the probability model is based on Poisson distribution.

4. The global tracking system of claim 1, wherein a first object record and a second object record among the object records respectively correspond to a first image capturing device and a second image capturing device,
wherein the at least one processor determines that a distance between the geographical coordinate comprised in the first object record and the geographical coordinate comprised in the second object record is smaller than a first threshold, the at least one processor determines that a time difference between the timestamp comprised in the first object record and the timestamp comprised in the second object record is smaller than a second threshold,
wherein the at least one processor considers that a first object instance corresponding to the first object record and a second object instance corresponding to the second object record are overlapped and a first object corresponding to the first object record and a second object corresponding to the second object record are the same object in the real world, and the at least one processor adjusts the geographical coordinate comprised in the first object record to be the same as the geographical coordinate comprised in the second object record.

5. The global tracking system of claim 4, wherein the first object record corresponds to a first image capturing device, a mapping function is defined between a plurality of image pixels and a plurality of geographical coordinates of the pre-designated view area corresponding to the first image capturing device, and the at least one processor further adjust the mapping function according to the distance.

6. A global tracking system, comprising:
a plurality of image capturing devices being deployed in a space, wherein each of the image capturing devices sees a pre-designated view area in the space, and the image capturing devices leave out at least one blind area uncovered by the image capturing devices in the space; and
at least one processor, being configured to receive a sequence of images from each of the image capturing devices, detect a plurality of object instances, and generate an object record for each of the object instances, wherein each of the object instances is detected from one of the images, each of the object instances corresponds to an object record, each of the object records comprises a tracking identity, a timestamp, and a geographical coordinate where the corresponding object located, wherein the object records with the same tracking identity correspond to the same object and the same image capturing device; and
wherein the at least one processor detects a first appearance of a specific object viewed by a specific image capturing device, and the first appearance happened at a first time instant and at a first geographical coordinate,
wherein the at least one processor deduces at least one candidate object that is entering and has not exited from a specific blind area due to having no object record generated after entering the specific blind area according to a model based on the first time instant, the first geographical coordinate, and a second geographical coordinate and a second timestamp of each candidate object record, wherein the specific blind area is neighbor to the pre-designated view area corresponding to the specific image capturing device,
wherein the at least one processor determines that the specific object is one of the at least one candidate object by calculating a similarity between the specific object and each candidate object, and determines that the specific object is exiting the specific blind area.

7. The global tracking system of claim 6, wherein the at least one processor deduces the at least one candidate object from the objects with reference to a probability model,
wherein for each candidate object, the probability model generates a probability based on the first geographical coordinate of the first appearance of the specific object, the corresponding second geographical coordinate, and a time length between the first time instant of the first appearance of the specific object and the corresponding second time instant.

8. The global tracking system of claim 6, wherein the probability model is a hidden Markov Chain model.

9. The global tracking system of claim 6, wherein a first object record and a second object record among the object records respectively correspond to a first image capturing device and a second image capturing device,
wherein the at least one processor determines that a distance between the geographical coordinate comprised in the first object record and the geographical coordinate comprised in the second object record is smaller than a first threshold, the at least one processor determines that a time difference between the timestamp comprised in the first object record and the timestamp comprised in the second object record is smaller than a second threshold,
wherein the at least one processor considers that a first object instance corresponding to the first object record and a second object instance corresponding to the second object record are overlapped and a first object corresponding to the first object record and a second object corresponding to the second object record are the same object in the real world, and the at least one processor adjusts the geographical coordinate comprised in the first object record and the geographical coordinate comprised in the second object record to a same geo-location.

10. The global tracking system of claim 6, wherein the first object record corresponds to a first image capturing device, a mapping function is defined between a plurality of image pixels and a plurality of geographical coordinates of the pre-designated view area corresponding to the first image capturing device, and the at least one processor further adjust the mapping function according to the distance.

11. A cloud system, being adapted to cooperate with a plurality of image capturing devices, each of the image capturing devices seeing a pre-designated view area in a space, and the image capturing devices leaving out at least one blind area uncovered by the image capturing devices in the space, the cloud system comprising:
a transceiving interface, being configured to receive a sequence of images from each of the image capturing devices; and
at least one processor, being electrically connected to the transceiving interface, and being configured to detect a plurality of object instances and generate an object record for each of the object instances, wherein each of the object instances is detected from one of the images, each of the object records comprises a tracking identity, a timestamp, and a geographical coordinate where the corresponding object located, and the object records with the same tracking identity correspond to the same object and the same image capturing device;
wherein the at least one processor determines that a specific object among the objects has no object record within a pre-determined time interval, finds out that a specific object record corresponds to a last appearance of the specific object from the object records in response to determining that the specific object has no object record within the pre-determined time interval, finds out that a distance between the geographical coordinate comprised in the specific object record and a boundary of a specific blind area of the at least one blind area is within a pre-determined range, and projects that the specific object is entering into the specific blind area in the pre-determined time interval in response to finding out that the distance between the geographical coordinate comprised in the specific object record and the boundary of the specific blind area is within the pre-determined range.

12. The cloud system of claim 11, wherein the at least one processor projects that the specific object is entering into the specific blind area in the pre-determined time interval with reference to a probability model,
wherein the probability model generates a probability based on a last-appeared time of the specific object and the distance between the geographical coordinate comprised in the specific object record and the boundary of the specific blind area.

13. The cloud system of claim 11, wherein the probability model is based on Poisson distribution.

14. The cloud system of claim 11, wherein a first object record and a second object record among the object records respectively correspond to a first image capturing device and a second image capturing device,
wherein the at least one processor determines that a distance between the geographical coordinate comprised in the first object record and the geographical coordinate comprised in the second object record is smaller than a first threshold, the at least one processor determines that a time difference between the timestamp comprised in the first object record and the timestamp comprised in the second object record is smaller than a second threshold,
wherein the at least one processor considers that a first object instance corresponding to the first object record and a second object instance corresponding to the second object record are overlapped and a first object corresponding to the first object record and a second object corresponding to the second object record are the same object in the real world, and the at least one processor adjusts the geographical coordinate comprised in the first object record to be the same as the geographical coordinate comprised in the second object record.

15. The cloud system of claim 14, wherein the first object record corresponds to a first image capturing device, a mapping function is defined between a plurality of image pixels and a plurality of geographical coordinates of the pre-designated view area corresponding to the first image capturing device, and the at least one processor further adjust the mapping function according to the distance.

16. A cloud system, being adapted to cooperate with a plurality of image capturing devices, each of the image capturing devices seeing a pre-designated view area in a space, and the image capturing devices leaving out at least one blind area uncovered by the image capturing devices in the space, the cloud system comprising:
a transceiving interface, being configured to receive a sequence of images from each of the image capturing devices; and
at least one processor, being electrically connected to the transceiving interface, and being configured to detect a plurality of object instances and generate an object record for each of the object instances, wherein each of the object instances is detected from one of the images, each of the object instances corresponds to an object record, each of the object records comprises a tracking identity, a timestamp, and a geographical coordinate where the corresponding object located, wherein the object records with the same tracking identity correspond to the same object and the same image capturing device; and
wherein the at least one processor detects a first appearance of a specific object viewed by a specific image capturing device, and the first appearance happened at a first time instant and at a first geographical coordinate,
wherein the at least one processor deduces at least one candidate object that is entering and as not exited from a specific blind area due to having no object record generated after entering the specific blind area according to a model based on the first time instant, the first geographical coordinate, and a second geographical coordinate and a second timestamp of each candidate object record, wherein the specific blind area is neighbor to the pre-designated view area corresponding to the specific image capturing device,
wherein the at least one processor determines that the specific object is one of the at least one candidate object by calculating a similarity between the specific object and each candidate object, and determines that the specific object is exiting the specific blind area.

17. The cloud system of claim 16, wherein the at least one processor deduces the at least one candidate object from the objects with reference to a probability model,
wherein for each candidate object, the probability model generates a probability based on the first geographical coordinate of the first appearance of the specific object, the corresponding second geographical coordinate, and a time length between the first time instant of the first appearance of the specific object and the corresponding second time instant.

18. The cloud system of claim 16, wherein the probability model is a hidden Markov Chain model.

19. The cloud system of claim 16, wherein a first object record and a second object record among the object records respectively correspond to a first image capturing device and a second image capturing device,
wherein the at least one processor determines that a distance between the geographical coordinate comprised in the first object record and the geographical coordinate comprised in the second object record is smaller than a first threshold, the at least one processor determines that a time difference between the timestamp comprised in the first object record and the timestamp comprised in the second object record is smaller than a second threshold,
wherein the at least one processor considers that a first object instance corresponding to the first object record and a second object instance corresponding to the second object record are overlapped and a first object corresponding to the first object record and a second object corresponding to the second object record are the same object in the real world, and the at least one processor adjusts the geographical coordinate comprised in the first object record and the geographical coordinate comprised in the second object record to a same geo-location.

20. The cloud system of claim 16, wherein the first object record corresponds to a first image capturing device, a mapping function is defined between a plurality of image pixels and a plurality of geographical coordinates of the pre-designated view area corresponding to the first image capturing device, and the at least one processor further adjust the mapping function according to the distance.
